(19) United States
(12) Patent Application Publication
(10) Pub. No.: US 2003/0211886 A1
(43) Pub. Date: Nov. 13, 2003

(54) Protecting against impulse expenditure

(75) Inventors: Peter D. Buchanan, Glenelg (AU); Earle George Rowan, Milsons Point (AU)

Correspondence Address: OLIFF & BERRIDGE, PLC, P.O. BOX 19928, ALEXANDRIA, VA, 22320, US

(73) Assignee: WORLDSMART TECHNOLOGY PTY LTD., Wayville (AU)

(21) Appl. No.: 10/303,815

(22) Filed: Nov. 26, 2002

Related U.S. Application Data
(63) Continuation of application No. PCT/AU01/00776, filed on Jun. 29, 2001.

(30) Foreign Application Priority Data
Jun. 29, 2000 (AU) PQ 8446

(51) Int. Cl. A63F 13/00

(52) U.S. Cl. 463/29

(57) ABSTRACT

A method of protecting against impulse expenditure during an expenditure period includes the step prior to the commencement of the expenditure period, of using a digital information processing device to enter or select rules governing permissible expenditure during the expenditure period. During the expenditure period, expenditure controlling apparatus is used to control expenditure in accordance with the rules defined prior to the commencement of the expenditure period. The rules governing permissible expenditure are stored on a portable data storage device, and the portable data storage device is used to convey the rules to the expenditure controlling apparatus.

### FIELD OF THE INVENTION

This invention relates to a method and system for protecting against impulse expenditure. It relates particularly but not exclusively to a computerised rules-based system for limiting impulse purchases and to a system and apparatus for limiting impulse expenditure by controlling expenditure according to predefined rules.

### BACKGROUND TO THE INVENTION

It is relatively common for individuals to make rash purchasing or expenditure decisions which are later regretted. These may range from small items of expenditure, such as an unnecessary food item, to large items such as a house. In the case of larger items, legislation often provides a way of escaping from an unwise commitment; for example, there is often a “cooling off” period of a few days applicable to the purchase of a house or a car or an insurance policy, during which the purchaser may cancel the contract, perhaps on payment of a small penalty. However, for the majority of transactions there is no way of reversing unwise expenditure decisions after the event.

There are many causes for rash expenditure decisions. These include pressure from a sales person such as an insurance agent selling an unnecessary insurance product, powerful advertising which temporarily overcomes a consumer's rational judgement, an addiction such as an inability to limit the consumption of alcohol to a sensible level, and excitement which may cause a person to overspend at gambling.

Existing methods of spending for the purchase of goods and services do not in general allow any pre-commitment by the spender. Credit cards usually have a credit limit, but the credit limit is often significantly higher than the amount of expenditure which can be justified for impulse expenditure. Electronic funds transfer accounts often have a limit on transaction size. However, the credit limit on a credit card account does not prevent a person from spending all of the money in the person's wallet and/or bank account. Further, the transaction size limit on an electronic funds transfer account exists for prevention of fraud on that account, and does not prevent the account holder from engaging in undesirable impulse expenditure.

### SUMMARY OF THE INVENTION

According to a first aspect of the invention, there is provided a method of protecting against impulse expenditure during an expenditure period, including the step's of:

(a) prior to the commencement of the expenditure period, using a digital information processing device to enter or select rules governing permissible expenditure during the expenditure period;

(b) during the expenditure period, using expenditure controlling apparatus to control expenditure in accordance with the rules defined prior to the commencement of the expenditure period;

wherein the rules governing permissible expenditure are stored on a portable data storage device, and the portable data storage device is used to convey the rules to the expenditure controlling apparatus; and

wherein the expenditure controlling apparatus is a gaming machine or a device attached to a gaming machine, and the expenditure period is a period spent operating the gaming machine.

The impulse expenditure may be any suitable type of impulse expenditure. One suitable type of impulse expenditure is gambling.

The digital information processing device may be any suitable device. One suitable device is a personal computer. Another suitable device is a purpose-built computer similar to an automatic teller machine or an Internet kiosk.

The expenditure controlling apparatus is capable of operating in accordance with the predefined expenditure rules to limit expenditure. Another suitable type of apparatus is an electronic funds transfer device which may also be used within a shop to limit purchases made by a customer in accordance with the predefined rules.

The portable data storage device may be in any suitable form, and may operate in any suitable manner. In a preferred arrangement, the portable data storage device also carries personal identification data which enables the portable data storage device to be used for electronic funds transfer. In a particularly preferred arrangement the portable data storage device is a SmartCard or an equivalent device.

The rules governing permissible expenditure may be any suitable rules. In a preferred embodiment, the rules include:

(a) differentiation between different categories of expenditure;

(b) budget amounts for different categories of expenditure;

(c) rules for adjusting budget amounts if the budgeted amount for a category of expenditure is exceeded; and

(d) rules specifying circumstances in which it is not permissible to exceed budgeted amounts.

Preferably, the rules further include prioritisation of different categories of expenditure.

As an additional feature, the expenditure controlling apparatus may dynamically monitor expenditure flow and provide an indication, based on expenditure rates, of a time at which a budgeted expenditure limit will be reached.

Alteration of the rules governing permissible expenditure may be governed in any suitable manner. Alternation may be precluded for a predefined time after the rules have been entered or selected. Alternatively, alteration may be precluded while the expenditure controlling apparatus is in operation.

According to a second aspect of the invention, there is provided a method of protecting against impulse expenditure during an expenditure period, including the steps of:

(a) prior to the commencement of the expenditure period, using a digital information processing device to enter or select rules governing permissible expenditure during the expenditure period;

(b) during the expenditure period, using expenditure controlling apparatus to control expenditure in accordance with the rules defined prior to the commencement of the expenditure period;

wherein the rules governing permissible expenditure are stored on a portable data storage device, and the portable data storage device is used to convey the rules to the expenditure controlling apparatus; and

wherein the expenditure controlling apparatus dynamically monitors expenditure flow and provides an indication, based on expenditure rates, of a time at which a budgeted expenditure limit will be reached.

The expenditure controlling apparatus may be any suitable type of apparatus. One suitable type of apparatus is a gaming machine or a device attached to a gaming machine which is capable of operating in accordance with the predefined expenditure rules to limit expenditure. Another suitable type of apparatus is an electronic funds transfer device within a shop which limits purchases made by a customer in accordance with the predefined rules.

According to another aspect of the invention, there is provided a system for protecting against impulse expenditure during an expenditure period, including:

(a) a digital information processing device;

(b) software operating on the digital information processing device which allows a user to enter or select rules governing permissible expenditure during the expenditure period;

(c) expenditure controlling apparatus; and

(d) software operating on the expenditure controlling apparatus to control expenditure in accordance with the predefined rules;

(e) a portable data storage device;

wherein the portable data storage device is used to convey the rules from the digital information processing device to the expenditure controlling apparatus; and

wherein the expenditure controlling apparatus is a gaming machine or a device attached to a gaming machine.

The portable data storage device may also carry personal identification data associated with a single user which enables the portable data storage device to be used for electronic funds transfer.

Whilst the system may consist of a single digital information processing device and a single expenditure controlling apparatus, the system is most effective when there are multiple digital information processing devices, multiple expenditure controlling apparatus, and multiple portable data storage devices. A portable storage device is programmed with rules at any of the digital information processing devices, and is used to convey the rules to any of the expenditure controlling apparatus.

In some embodiments a digital information processing device may also function as expenditure controlling apparatus.

According to another aspect of the invention, there is provided expenditure controlling apparatus including:

(a) electronic funds transfer apparatus, for transferring funds expended by a user;

(b) a data storage device reader, for reading rules stored on a data storage device relating to expenditure of funds permitted for a user; and

(c) software operating on the expenditure controlling apparatus to control the transfer of funds expended by the user in accordance with the rules read from the data storage device;

wherein the expenditure controlling apparatus is a gaming machine or is attached to a gaming machine.

According to yet another aspect of the invention, there is provided expenditure controlling apparatus including:

(a) electronic funds transfer apparatus, for transferring funds expended by a user;

(b) a data storage device reader, for reading rules stored on a data storage device relating to expenditure of funds permitted for a user; and

(c) software operating on the expenditure controlling apparatus to control the transfer of funds expended by the user in accordance with the rules read from the data storage device;

further including an expenditure flow monitor which dynamically monitors expenditure flow and provides an indication, based on expenditure rates, of a time at which a budgeted expenditure limit will be reached.

### BRIEF DESCRIPTION OF THE DRAWINGS

The invention will hereinafter be described in greater detail by reference to the attached drawings which show an example form of the invention. It is to be understood that the particularity of those drawings does not supersede the generality of the preceding description of the invention.

FIG. 1 is a schematic illustration of an embodiment of the invention relating to controlling expenditure within the context of home budgeting.

FIG. 2 is a flow diagram illustrating an embodiment of the invention within the context of a gaming application.

### DETAILED DESCRIPTION

The drawings show two example forms of the invention, one for use in a general budgeting context, and one for use specifically in controlling gambling expenditure. In both cases, the method allows individuals to set their own personal expenditure rules at a time when they are exercising rational judgment.

The preferred embodiments of the method illustrated in the Figures require three specific elements:

1. A device that allows a user to set and modify rules governing expenditure. This can be implemented on a Personal Computer. A suitable program can be written to allow rules to be defined by the user. This may be implemented over the Internet or may also be implemented as a part of the third element (which is described below).

2. A device that carries and executes the rules. This device can be a Smartcard or other technology that can be easily carried by a user and allows the storage and implementation of the pre-set business rules.

3. A device or devices that offers an interface to the real world. This device may be in many forms and may be included as part of a machine or other device. In operation this may also include the functionality of the first element (which is described above). The device acts to implement the rules which are carried on the second element (which is described above).

In the preferred arrangements shown in the Figures, the carried device is a Smartcard and the other devices are a PC (personal computer) that allows the rules to be set on the card and a terminal that provides credit and debit facilities. Each device is exclusively identified to the others. This can be implemented by the 3DES (Location, Terminal Type, Terminal Number) cryptogram, which is generated by an authorized agent and held secret except to a Smartcard.

On insertion to a PC or terminal a Smartcard reads the cryptogram and deciphers the code. The rules stored on the Smartcard then cause the performance of a specific function.

Software operating on the PC allows rules to be set on the Smartcard. These rules determine how an external device will operate given instructions by the Smartcard. Such rules may include the control of a financial purse (spend control) or the control of a physical attribute of an external machine (programmed control). The software may be resident on the PC or remotely operated over the Internet.

The terminal may be a stand-alone device or a component part of another machine. The terminal identifies itself to a Smartcard by transferring its cryptogram to the card. The terminal may provide such functionality as requesting funds from the card, depositing funds to the card or requesting control parameters from the card.

The Smartcard carries a set of operational rules. These rules are specific to the individual user; they may provide such functionality as financial budgeting and/or control of physical devices.

Household Budget Control

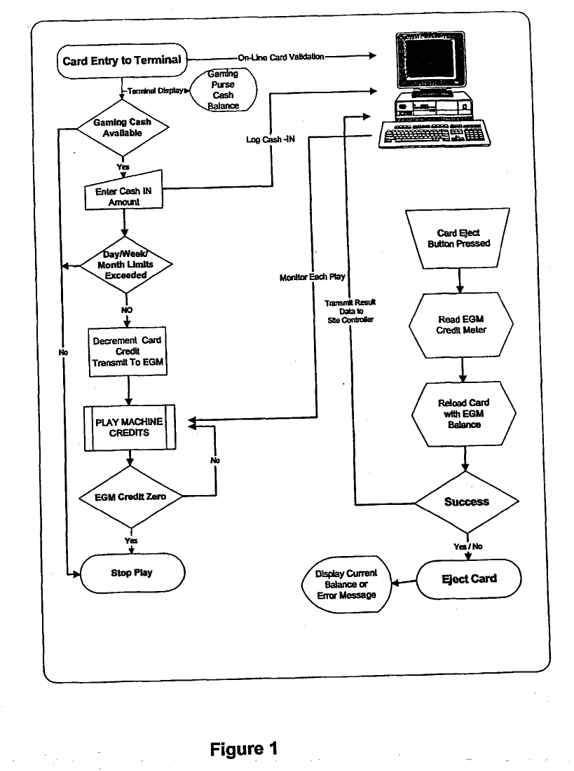

Referring now to FIG. 1, there is shown a household budget control system.

As a first step, a user accesses an Internet site from a remote location and is presented with software that allows certain purchase or payment functionality. The user has a PC which includes a Smartcard terminal. The remote program identifies itself to the Smartcard using a pre-defined cryptogram. The Smartcard is then made aware of the functionality of the remote program, what access to card functions is available and in this case which payments can be credited to or debited from the Smartcard.

As an instance a wallet may be set to allow funds to be drawn for several payments such as electricity, food, house, car, petrol, fun; these payments are prioritised in accordance with their importance.

The card has access to the users bank account through the Internet and the bank balance is stored on the users card. Payments may be declared as constant or variable and quantified in dollar and cent terms. A constant payment cannot be dynamically modified; a variable can be set to operate within predefined parameters.

In the present example, there are two constant payments, namely house and car. These are fixed value payments that must be made each month. These have priority 1 (house) and 2 (car). There are no variables associated with these payments, as each must be met (House being most important).

Each of the other payments, food, petrol, fun, can be assigned a fixed portion 0 to 100 percent and a dynamically variable rate.

In operation there must always be sufficient funds to meet the fixed payments. Variables can be used within the preset percentages for any purpose. In other words, if a payment is made for petrol that exceeds the petrol spend limit a warning is issued and funds are drawn from the lowest priority purse to top up this payment. Food is higher priority than petrol and fun is least important so the fun purse is decremented for the petrol purchase.

Balances can be checked at any terminal or PC and stored in the users' PC at a later time. Vector analysis is performed for each purse spend and this is used to assist the user in setting the requirement balances for future spends.

In the present scenario the user places the card in a PC and a program loads the current balances and vector data. From this, the program predicts the required funds for the next week/month and assigns balances automatically to each spend purse.

Gaming Expenditure Control

In this particular example, a Gaming Machine is equipped with a secure terminal to deposit and redeem cash credits from a Smartcard. For security reasons the terminal is preferably enclosed within the Gaming Machine body, and banking standard security practices are adhered to in the system operation.

An on-line backup of each transaction between card and machine is preferably maintained in an on-site Central Control PC. This allows a back trace to be performed on all cards for the purpose of cash redemption should a card be damaged. Further, it allows a lost or stolen card to be ‘Hot Listed’ immediately it is reported.

The on-site PC can be connected via dial up modem to a Main Data Base at a remote location. An on card PIN number must be provided by the user; this prevents lost or stolen cards from being used by unauthorised persons.

Dynamic Purse Management

A purse on a Smartcard is a storage area where funds can be accumulated and used in a secure manner that is resistant to fraudulent misuse. In Dynamic Purse Management, the funds are controlled by a series of gates that can dynamically monitor the funds flow and predict the time, based on previous spend rates and current spend rates, that the fund pool will reach zero for the specified purse. Further to this, daily weekly and monthly spend limits can be set to ensure that available funds are distributed according to the preset rules.

There is preferably also a separate WINS purse, the function of which is also controlled by a reverse gate. This gate allows the user to pre-set the amount of win available for continued play and can be set from 100% to 0%. A user sets the gates with predefined values and these values determine access to funds on a time-controlled basis. The gate values can be set by the user or they may be set as a service by the venue, by a social worker or by a legislative process. Once set, gates cannot be reprogrammed for a predefined period such as 24 hours.

A player is required to pass a ten point ID plan in order to receive a card, effectively reducing the possibility of a player having more than one card.

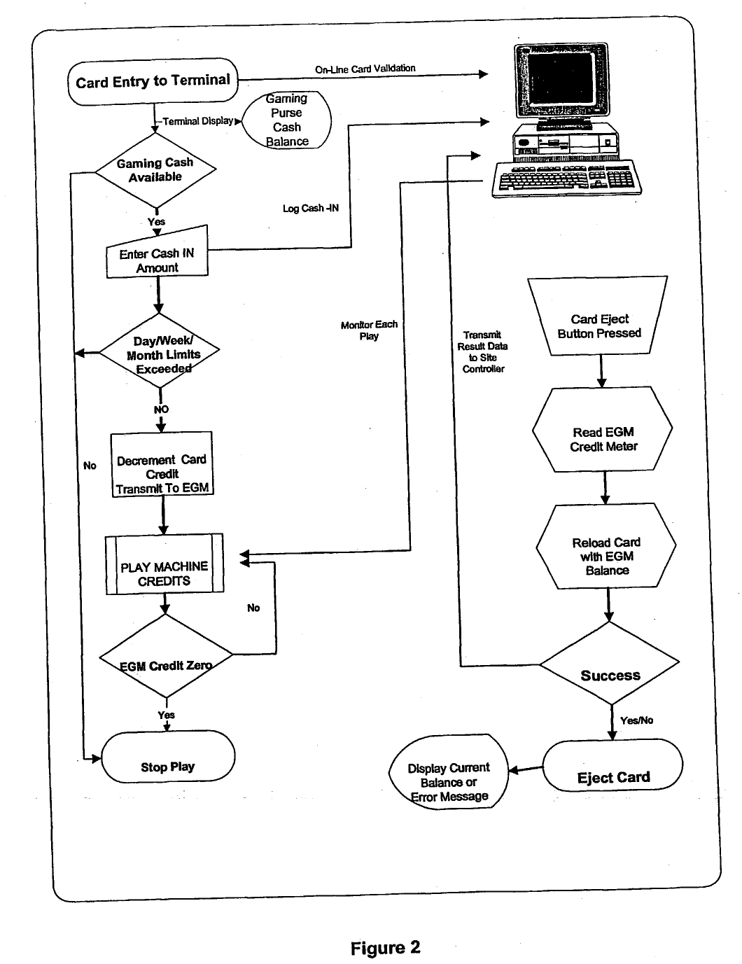

The Gaming Purse is separate from all other purses that may exist on the card, so that a single card can be used both for the budgeting system illustrated in FIG. 1 and for the gaming method illustrated in FIG. 2.

A person may be permitted to load funds to the card using a Gaming Machine or stand alone Note Validator. However, regardless of the loading method, the pre-set limits determine spend and a PIN protects the user's funds. In operation a user transfers cash to the Smartcard. The Smartcard is then inserted into a Gaming Machine Reader and the user enters a PIN. This is followed by an amount entry via the integral keypad. The specified funds are loaded into the Gaming Machine, whereafter the user can begin play.

The load transaction is recorded in the Central Control Computer and also on the Smartcard. The Smartcard maintains a record of the last ten transactions, which can be ‘played back’ on the Central Control Computer.

If the play funds in the Gaming Machine are exhausted the user will be prompted to insert further funds providing that the user's day, week or month limits have not been exceeded.

When the user decides to cease play the EJECT button is pressed. The terminal requests from the gaming machine the current balance and performs a ‘Cancel Credit’ to release the funds. The balance is then loaded back to the card, in the following manner

1. Funds are loaded to the gaming purse up to the Maximum Purse Balance.

2. Any excess funds are loaded to the ‘WINS PURSE’

The ‘WINS PURSE’ can be drawn on to top up the Gaming Purse again providing that limits are not exceeded.

Funds stored in the Smartcard can be redeemed for cash at the Cashiers desk or maintained on card for use at a later date. It may also be possible to transfer funds from the gaming Purse to the banking cash purse or a bank account. At any time it should be possible for a user to read the balance in any purse, obtain a predictive value of current spend rate or determine current available balance.

One or more of the following pre-commitment methods may also use the card to control the gaming machine:

1. The machine may be disabled until the card is inserted.

2. The Note Validator mechanism may be enabled or disabled.

3. The coin insertion mechanism may be enabled or disabled.

4. All funds may be dumped to card on EJECT.

5. A pre-set wager may be the only allowable bet.

It is to be understood that various alterations, additions and/or modifications may be made to the parts previously described without departing from the ambit of the present invention.

The claims defining the invention are as follows:

1. A method of protecting against impulse expenditure during an expenditure period, including the steps of:
(a) prior to the commencement of the expenditure period, using a digital information processing device to enter or select rules governing permissible expenditure during the expenditure period;
(b) during the expenditure period, using expenditure controlling apparatus to control expenditure in accordance with the rules defined prior to the commencement of the expenditure period;
wherein the rules governing permissible expenditure are stored on a portable data storage device, and the portable data storage device is used to convey the rules to the expenditure controlling apparatus; and
wherein the expenditure controlling apparatus is a gaming machine or a device attached to a gaming machine, and the expenditure period is a period spent operating the gaming machine.

2. A method of protecting against impulse expenditure during an expenditure period, including the steps of:
(a) prior to the commencement of the expenditure period, using a digital information processing device to enter or select rules governing permissible expenditure during the expenditure period;
(b) during the expenditure period, using expenditure controlling apparatus to control expenditure in accordance with the rules defined prior to the commencement of the expenditure period;
wherein the rules governing permissible expenditure are stored on a portable data storage device, and the portable data storage device is used to convey the rules to the expenditure controlling apparatus; and
wherein the expenditure controlling apparatus dynamically monitors expenditure flow and provides an indication, based on expenditure rates, of a time at which a budgeted expenditure limit will be reached.

3. A method according to claim 1 or claim 2 wherein the portable data storage device also carries personal identification data which enables the portable data storage device to be used for electronic funds transfer.

4. A method according to any one of claims 1 to 3 wherein the rules include:
(a) differentiation between different categories of expenditure;
(b) budget amounts for different categories of expenditure;
(c) rules for adjusting budget amounts if the budgeted amount for a category of expenditure is exceeded; and
(d) rules specifying circumstances in which it is not permissible to exceed budgeted amounts.

5. A method according to claim 4 wherein the rules further include prioritisation of different categories of expenditure.

6. A method according to any one of claims 1 to 5 wherein alteration of the rules governing permissible expenditure is precluded for a predefined time after the rules have been entered or selected.

7. A method according to claim 1 wherein the expenditure controlling apparatus dynamically monitors expenditure flow and provides an indication based on expenditure rates, of a time at which a budgeted expenditure limit will be reached.

8. A system for protecting against impulse expenditure during an expenditure period, including:
(a) a digital information processing device;
(b) software operating on the digital information processing device which allows a user to enter or select rules governing permissible expenditure during the expenditure period;
(c) expenditure controlling apparatus; and
(d) software operating on the expenditure controlling apparatus to control expenditure in accordance with the predefined rules;
(e) a portable data storage device;
wherein the portable data storage device is used to convey the rules from the digital information processing device to the expenditure controlling apparatus; and
wherein the expenditure controlling apparatus is a gaming machine or a device attached to a gaming machine.

9. A system according to claim 8 wherein the portable data storage device also carries personal identification data associated with a single user which enables the portable data storage device to be used for electronic funds transfer.

10. A system according to claim 8 or claim 9 wherein there are multiple digital information processing devices, multiple expenditure controlling apparatus, and multiple portable data storage devices, wherein further any of the portable storage devices may be programmed with rules at any of the digital information processing devices, and may be used to convey the rules to any of the expenditure controlling apparatus.

11. A method according to any one of claims 8 to 10 wherein a digital information processing device may also function as expenditure controlling apparatus.

12. Expenditure controlling apparatus including:
(a) electronic funds transfer apparatus, for transferring funds expended by a user;
(b) a data storage device reader, for reading rules stored on a data storage device relating to expenditure of funds permitted for a user; and
(c) software operating on the expenditure controlling apparatus to control the transfer of funds expended by the user in accordance with the rules read from the data storage device;
wherein the expenditure controlling apparatus is a gaming machine or is attached to a gaming machine.

13. Expenditure controlling apparatus including:
(a) electronic funds transfer apparatus, for transferring funds expended by a user;
(b) a data storage device reader, for reading rules stored on a data storage device relating to expenditure of funds permitted for a user; and
(c) software operating on the expenditure controlling apparatus to control the transfer of funds expended by the user in accordance with the rules read from the data storage device;
further including an expenditure flow monitor which dynamically monitors expenditure flow and provides an indication, based on expenditure rates, of a time at which a budgeted expenditure limit will be reached.

14. Expenditure controlling apparatus according to claim 13 wherein the expenditure controlling apparatus is a gaming machine or is attached to a gaming machine.
